(19) United States
(12) Patent Application Publication
(10) Pub. No.: US 2025/0090418 A1
(43) Pub. Date: Mar. 20, 2025

(54) Elevated CPR Apparatus and Method for Using the Same

(71) Applicant: Care2 Innovations Inc., Costa Mesa, CA (US)

(72) Inventors: Steve Islava, Laguna Niguel, CA (US); Rick Van Auken, Laguna Hills, CA (US)

(21) Appl. No.: 18/468,064

(22) Filed: Sep. 15, 2023

(51) Int. Cl. A61H 31/00

(52) U.S. Cl. CPC A61H 31/008; A61H 31/006; A61H 2201/0192

(57) ABSTRACT

A head-up CPR board and method for using the same. The head-up CPR board gradually elevates the chest of a patient to a 15-degree angle and the head of the patient to a 30-degree angle. While CPR is being performed on the patient, a wedge insert is slowly and incrementally inserted beneath an incline portion of the head-up CPR board. By slowly elevating the patient, the head-up CPR board facilitates venous drainage through gravity and promotes improved circulation of oxygenated blood, leading to better neurological outcomes when Return of Spontaneous Circulation (ROSC) occurs in cardiac arrest patients. By significantly enhancing cerebral brain blood flow, cerebral perfusion, and coronary perfusion, this can have a profound impact on the overall recovery and neurological well-being of patients. The head-up CPR also reduces pulmonary vascular resistance. This dual benefit contributes to better oxygenation and circulation, further improving patient outcomes.

### BACKGROUND

### Field of the Technology

The invention relates to the field of cardiopulmonary resuscitation (CPR) apparatuses and methods, specifically to apparatuses and methods for adjusting the relative incline of a patient for improved performance of cardiopulmonary resuscitation (CPR).

### Description of the Prior Art

Cardiopulmonary resuscitation or CPR has long been used to reinstate or preserve blood flow through a patient until further medical treatment arrives or can be implemented. CPR principally comprises a series of chest compressions delivered by hand or by an automated CPR device followed by a volume of air being forced into the patient's airway through mouth to mouth resuscitation or through a one-way valve disposed in a mask that is placed on the patient. Compressing the patient's chest raises the patient's blood pressure so that organs such as the brain continue to receive blood flow while air forced into the patient's lungs forces them to respire for an extended amount of time over what would have occurred had no assistance been given. When CPR was first implemented as a treatment regimen, the initial proscribed method included laying the patient in a supine position during the entire procedure.

Lately however, research has indicated that after performing CPR on a patient laying in the supine position, increasing the angle of the patient's head while continuing CPR has dramatically increased their chances of resuscitation and recovery. More specifically, under the theory that tilting the patient's head upward produces gravity-dependent venous drainage from the brain, cerebral venous sinuses, and the paravertebral venous plexus, the cerebral blood flow and the cerebral perfusion pressure of the patient is in turn increased. In other words, the patient's intracranial pressure is decreased while distal blood flow is increased. Additionally, it is thought that by performing CPR on a patient in a “head-up” position, the amount of concussive force due to blood being thrust into and out of the brain is decreased while blood flow to the patient's lungs is more favorably redistributed

Previous head-up CPR devices are comprised of plastic, rubber, or stiff foam and are not collapsible or do not have a folded or compact form. Therefore, during transit to an accident site, these head-up CPR devices not only take up valuable storage space within an emergency vehicle, they are also more prone to damage during transit given their rigid construction. Additionally, because of their construction, previous head-up CPR devices can be prohibitively expensive, thus limiting its accessibility to patients. For example, some CPR devices comprise a means for mechanically raising a patient to a desired angle upon actuation of an electrically powered motor, however such devices are expensive, bulky, and difficult to clean.

What is needed therefore is an apparatus and method for quickly and efficiently supporting a patient in a head-up position for CPR treatment or other treatments requiring resuscitation of the patient while the patient is still present at the scene of the emergency. The apparatus should be easily transported and stored while also being inexpensive, disposable, and easy to use.

### BRIEF SUMMARY

The current invention comprises a CPR board which gradually elevates the chest to a 15-degree angle and the head to a 30-degree angle. By slowly elevating the patient, the CPR board of the current invention facilitates venous drainage through gravity and promotes improved circulation of oxygenated blood, leading to better neurological outcomes when Return of Spontaneous Circulation (ROSC) occurs in cardiac arrest patients. By significantly enhancing cerebral brain blood flow, cerebral perfusion, and coronary perfusion, this can have a profound impact on the overall recovery and neurological well-being of patients. Additionally, the CPR board of the current invention not only improves venous drainage, but also reduces pulmonary vascular resistance. This dual benefit contributes to better oxygenation and circulation, further improving patient outcomes.

The current CPR board is specifically configured to be used with automated CPR machines or devices such as the Lucas® chest compression system manufactured by Stryker Medical®. This compatibility ensures seamless integration into cardiac arrest management protocols, providing optimal patient care and safety.

To ensure proper usage and maximize the benefits of the current CPR Board, a user performs manual CPR on a patient in the supine position for two minutes to prime the cardio cerebral circuit. Next, a backplate or other portion of the automated CPR device is placed in the current CPR board and then secured to it with hook and loop straps or other coupling means. The patient is gently laid onto the current CPR board and their head is immobilized using a plurality of provided head immobilizers. CPR is recommenced with the automated CPR device now in place while gradually raising the head with the wedge insert of the current invention. Over two minutes, the patient's head is slowly elevated, using a plurality of markings or notches disposed on the wedge insert as a guide. In one particular embodiment, the wedge insert is slid further under the current CPR board every 30 seconds until it is completely inserted.

The current invention provides a cardiopulmonary resuscitation (CPR) board for raising a patient to an inclined position. The CPR board includes a base, an adjustable incline coupled to the base, and an internal channel that is defined between the base and the incline. A removable wedge insert is also provided which is configured to be inserted into the internal channel, wherein the wedge insert is configured to rotate the incline relative to the base as it is being inserted into the internal channel.

In one embodiment, the incline of the CPR board comprises a first incline portion coupled to the base and a second incline portion coupled to the first incline portion, wherein the second incline portion is configured to rotate relative to the base as the wedge insert is inserted into the internal channel. In a related embodiment, an indentation is defined within a surface of the first incline portion, wherein the indentation is configured to accommodate at least a portion of an automated CPR device. In a further related embodiment, the second incline portion is configured to rotate about a joint that is disposed between the second incline portion and the first incline portion.

In another embodiment, the CPR board also comprises an indentation that is defined within a surface of the incline, wherein the indentation is configured to accommodate at least a portion of an automated CPR device.

In another embodiment, the CPR board also comprises at least one wall coupled to the base, wherein at least a portion of the incline rests upon the at least one wall when the CPR board is in an unactuated configuration.

In one embodiment, the internal channel of the CPR board is defined by a bottom surface of the incline, a top surface of the base, and at least one wall that is disposed between the incline and the base.

In another embodiment, the incline of the CPR board is configured to rotate about a joint that is disposed between the incline and the base.

In a further embodiment, the CPR board of claim also includes a plurality of adjustable head supports that are disposed on the incline. According to a related embodiment, each of the plurality of adjustable head supports comprises a planar portion which is configured to be selectively parallel relative to the incline when the head support is an expanded position and then bent along a seem when the head support is in an actuated position.

In one embodiment, the wedge insert of the CPR board comprises at least one longitudinal wall that comprises a tapered height.

In another embodiment, the wedge insert comprises a plurality of markings that are disposed thereon, wherein each one of the plurality of markings corresponds to a relative angle between the incline and the base when the wedge insert has been inserted into the internal channel up to that respective marking.

The current invention also provides a method for performing cardiopulmonary resuscitation (CPR) on a patient by a user. The method includes laying a patient on an incline of a CPR board, performing CPR on the patient while the incline is disposed at a first position relative to a base of the CPR board, and then manually raising the angle of the incline relative to the base of the CPR board until the incline is disposed at a second position relative to the base of the CPR board. CPR may then be performed on the patient while the incline is disposed at the second position relative to the base of the CPR board.

In one embodiment, manually raising the angle of the incline relative to a base of the CPR board until the incline is disposed at a second position relative to the base of the CPR board specifically includes inserting a wedge insert into an internal channel that is defined within the CPR board and then sliding the wedge insert in a distal direction through the internal channel. Distal movement of the wedge insert increases surface contact between the wedge insert and the incline which then rotates the incline relative to the base. In a related embodiment, sliding the wedge insert in a distal direction through the internal channel specifically includes sliding the wedge insert in the distal direction until a selected one of a plurality of markings disposed on the wedge insert is adjacently disposed to at least one wall that defines the internal channel.

In another embodiment, laying the patient on the incline of the CPR board comprises laying the patient across a first incline portion and a second incline portion, while raising the angle of the incline relative to the base of the CPR board until the incline is disposed at the second position relative to the base of the CPR board in turn comprises raising the angle of the second incline portion relative to the base.

In another embodiment, performing CPR on the patient while the incline is disposed at either the first position relative to the base of the CPR board or the second position relative to the base of the CPR board each comprise performing CPR on the patient with an automated CPR device that is coupled to or disposed on the CPR board.

In another embodiment, laying the patient on the incline of the CPR board comprises laying the patient on an automated CPR device coupled to the CPR board.

In a further embodiment, the method also includes disposing a head and neck of the patient within a pair of adjustable head supports that are disposed on the incline.

In one embodiment, the method also includes performing CPR on the patient while the angle of the incline is being manually raised relative to the base of the CPR board.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1A is a frontal perspective view of the CPR board of the current invention wherein a wedge insert is fully inserted therein.

FIG. 1B is a right side elevated view of the CPR board of FIG. 1A.

FIG. 2 is a rear perspective view of the CPR board of FIG. 1A when a distal end of the wedge insert is being inserted into an internal channel of the CPR board.

FIG. 3 is a rear perspective view of the CPR board of FIG. 2 when a second incline portion of the CPR board has been lifted to show the internal channel disposed there beneath.

FIG. 4 is a frontal perspective view of the CPR board of FIG. 1A when the CPR board is in a collapsed configuration.

FIG. 5A is a right side plan view of the CPR board of FIG. 1A comprising a backplate of an automated CPR device disposed therein when a patient has been disposed on the CPR board and when the wedge insert has been removed. The head of the patient rests upon a second incline portion of the CPR board which is substantially parallel to a base portion of the CPR board.

FIG. 5B is a right side plane view of the CPR board of FIG. 5A after the wedge insert has been inserted into an internal channel of the CPR board, the wedge insert rotating the second incline portion and the patient disposed thereon to a first angle relative to the base.

FIG. 5C is a right side plane view of the CPR board of FIG. 5B after the wedge insert has been inserted further into the internal channel of the CPR board, the wedge insert rotating the second incline portion and the patient disposed thereon to a second angle relative to the base.

FIG. 6A is a right side plan view of the CPR board of FIG. 1A comprising an automated CPR device disposed therein when a patient has been disposed on the CPR board and when the wedge insert has been removed. The head of the patient rests upon an incline of the CPR board which is disposed a first angle relative to a base portion of the CPR board.

FIG. 6B is a right side plane view of the CPR board of FIG. 6A after the wedge insert has been inserted into an internal channel of the CPR board, the wedge insert rotating the incline and the patient disposed thereon to a second angle relative to the base.

FIG. 6C is a right side plane view of the CPR board of FIG. 6B after the wedge insert has been inserted further into the internal channel of the CPR board, the wedge insert rotating the incline and the patient disposed thereon to a third angle relative to the base.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

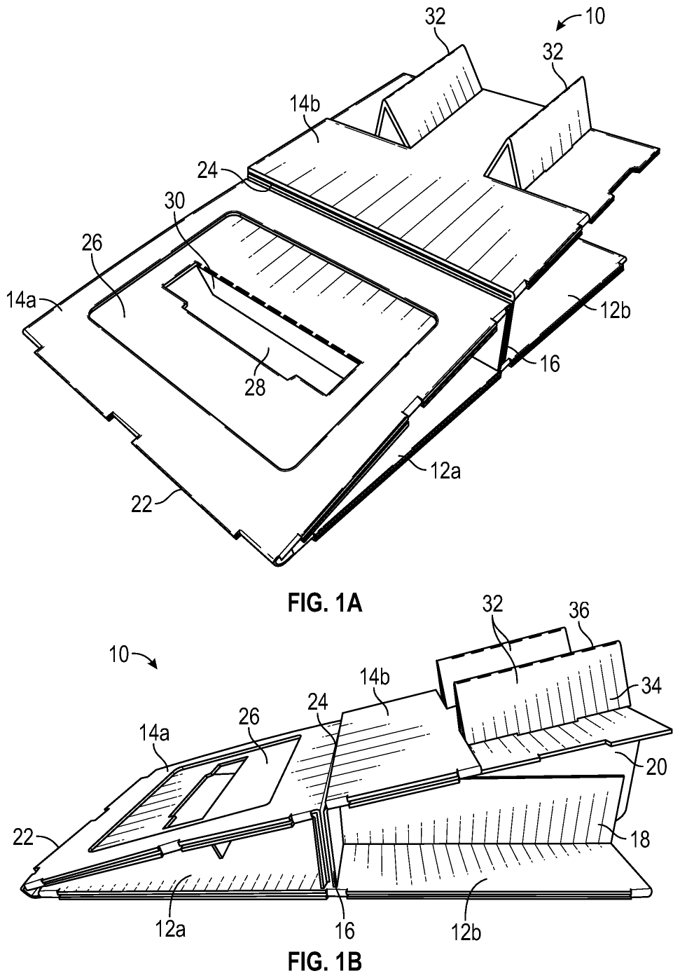

The current invention is an adjustable and collapsible rigid head-up CPR board which is seen in FIGS. 1A and 1B and is generally denoted by reference numeral 10. In certain embodiments, the head-up CPR board 10 comprises a base 12 coupled to an incline 14, the base 12 comprising a first base portion 12a and a second base portion 12b, and the incline 14 comprising a first incline portion 14a and a second incline portion 14b. The first base portion 12a is coupled to the first incline portion 14a together via a first joint 22 at a proximal edge of the first incline portion 14a. The second incline portion 14b is coupled to the opposing distal edge of the first incline portion 14a at a second joint 24. Disposed beneath the second joint 24 is a substantially vertical brace 16 which in some embodiments divides the base 12 between the first base portion 12a and the second base portion 12b. In some embodiments the brace 16 is coupled to both the base 12 and the incline 14, however in certain other embodiments the brace 16 is removably fitted or disposed within a slot or indentation defined in either the base 12 or the incline 14. The brace 16 is a removable component which may be selectively disposed within the head-up CPR board 10, however in other embodiments the brace 16 is comprised of portions of either or both the first and second incline portions 14a, 14b which are folded or otherwise manipulated so as to form the brace 16.

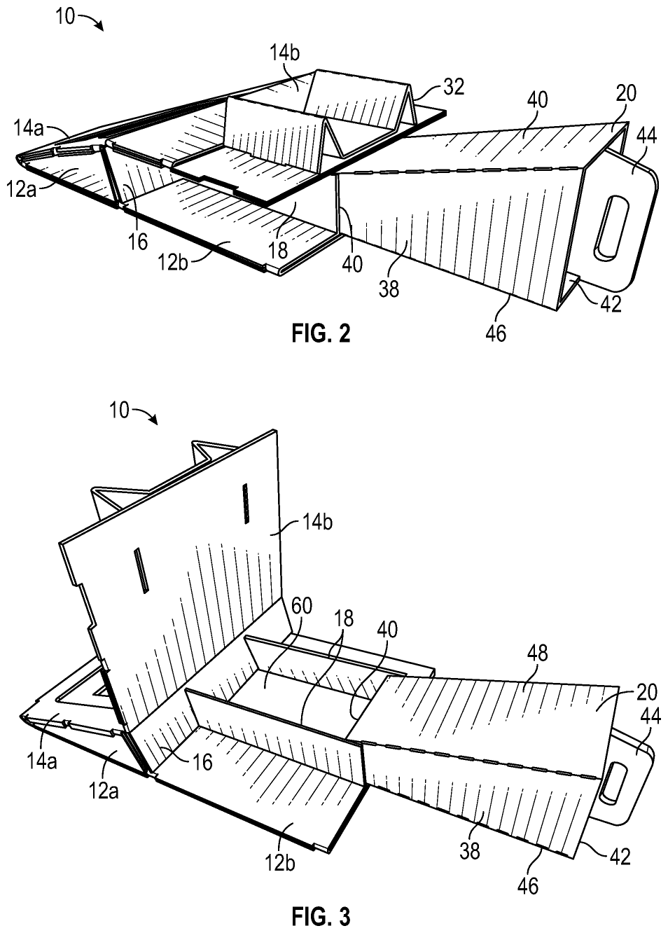

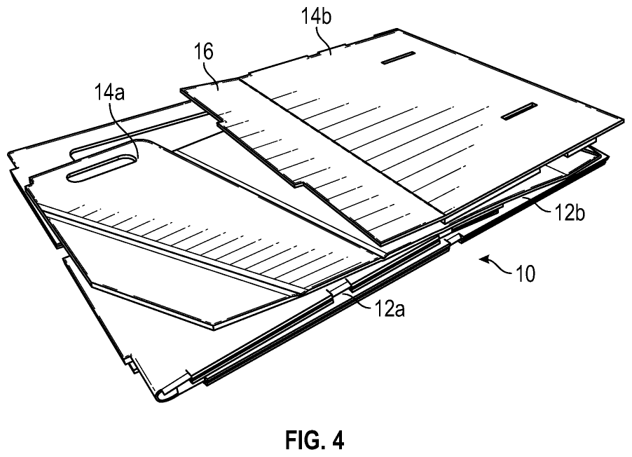

In certain embodiments the base 12 comprises a plurality of substantially vertical walls 18 which project perpendicularly upward relative to the substantially horizontal base 12 as best seen in FIG. 1A. In some embodiments, the plurality of walls 18 are disposed parallel to each other so as to form a hollow internal channel or volume 62 there between which accommodates a removable wedge insert 20 as further detailed below with regard to FIGS. 2 and 3. According to other embodiments, a track configured to accommodate the wedge insert 20 is defined in the upward facing surface of either portion of the base 12 within the internal channel 62.

The surface elements of the head-up CPR board 10, namely the base 12, the incline 14, the brace 16, and the walls 18 are comprised of a substantially rigid yet lightweight material such as plastic, cardboard, aluminum, or wood, however other similar materials now known or later devised may be used without departing from the original spirit and scope of the invention. The first and second joints 22, 24 in turn are preferably comprised of a flexible yet durable material such as nylon, leather, plastic composites, or other similar materials.

According to certain embodiments, the first incline portion 14a comprises an indentation 26 defined a portion through a thickness thereof. The indentation 26 is sized or configured to accommodate or maintain a removable automated CPR device or at least a portion of the automated CPR device therein. For example, according to certain embodiments, the indentation 26 is configured to accommodate the backplate portion of an automated CPR device, for example the LUCAS® Chest Compression System manufactured by Stryker Corporation® or the like. The indentation 26 is seen in FIGS. 1A and 1B as being substantially rectangular, however in other embodiments the indentation 26 may be any other shape so as to accommodate at least a portion of an automated CPR device. Disposed in a middle portion of the indentation 26 is a flap 30 that is rotatable relative to a surface of the indentation 26 along at least one edge of the flap 30. When actuated, the flap 30 is bent downwards, creating an aperture 28 through the first incline portion 14a. An edge of the flap 30 engages or otherwise interacts with the first base portion 12a when actuated or in the downward position, thereby providing additional structural support to the first incline portion 14a. In certain embodiments, the first base portion 12a comprises a slit, trench, or other means for accommodating or otherwise providing a seat for the edge of the flap 30.

In a related embodiment, the indentation 26 is defined across the entire incline 14, for example both the first incline portion 14a and the second incline portion 14b. Specifically, according to certain embodiments, the indentation 26 expands across both the first incline portion 14a and the second incline portion 14b so as to provide a single aperture or means for accommodating larger automated CPR devices, for example the CPR board of the AutoPulse® Resuscitation System manufactured by Zoll Medical®.

In certain embodiments, the second incline portion 14b comprises at least adjustable two head supports 32. Each head support 32 comprises a substantially planar portion 34 that is coupled or integral with the surface of the second incline portion 14b along one lateral edge and which remains free at an opposing lateral edge. In an expanded configuration, the planar portion 34 is substantially parallel with the second incline portion 14b. When actuated, the planar portion 34 is selectively bent or folded along a seem 36 so as to form a substantially triangular shape in combination with the second incline portion 14b as best seen in FIG. 1A. The planar portion 34 comprises a tab, an extension, or other means for insertion into a slit, aperture, or other means for engagement that is defined within the surface of the second incline portion 14b. To actuate each head support 32, the planar portion 34 is brought from a substantially flat orientation to a substantially triangular orientation by being bent along the seem 36. Being bent along the seem 36 brings the tab or other means for insertion of the planar portion 34 into proximity of the slit or other means for engagement of the second incline portion 14b so that the tab can then be inserted therein, thereby locking or fixing the planar portion 34 into place and form the head support 32. When the tab of the planar portion 34 is released from the second incline portion 14b, the planar portion 34 is permitted to extend back into a substantially flat position that is parallel to the surface of the second incline portion 14b. When both head supports 32 are in the actuated position as seen in FIG. 1A, a passage or space is formed there between which is sufficient to accommodate and support the head and neck of a patient therein.

In FIGS. 2 and 3, greater detail of the wedge insert 20 may be seen. In certain embodiments, the wedge insert 20 is a substantially trapezoidal shaped object comprising a top surface 48, a bottom surface 46, and at least one longitudinal wall 38 disposed there between. One lateral end of the at least one longitudinal wall 38 is disposed at a distal end 40 of the wedge insert 40 while the opposing lateral end of the at least one longitudinal wall 38 is disposed at a proximal end 42 of the wedge insert 20. The proximal end 42 of the wedge insert 20 further comprises a handle 44 coupled thereto. The at least one longitudinal wall 38 comprises a tapered height, thereby disposing or orientating the top surface 36 at an angle relative to the substantially horizontal bottom surface 46. More specifically, for example, the at least one longitudinal wall 38 comprises a first height adjacent to the distal end 40 which gradually increases along its length until reaching a maximum second height adjacent to the proximal end 42. The top surface 48 according to this embodiment is set an angle relative to the bottom surface 46, namely with a distal edge of the top surface 48 being closer to the bottom surface 46 than a proximal edge of the top surface 48. The wedge insert 20 is comprised of the same materials as the base 12, the incline 14, and/or the walls 18 of the head-up CPR board 10, however in certain other embodiments, the top surface 48, bottom surface 46, and the at least one longitudinal wall 38 of the wedge insert 20 are comprised of alternative materials which are known to provide a coefficient of friction which is not too high so as to prevent relative movement between the wedge insert 20 and the base 12, but also simultaneously not too low so that the wedge insert 20 does not inadvertently slip relative to the base 12. With complimentary surfaces, the wedge insert 20 can be slid into the head-up CPR board 10 at a consistent or measured speed while a patient is disposed on the head-up CPR board 10 as detailed further below.

In certain embodiments, adjustment of the second incline portion 14b relative to the second base portion 12b is done by insertion of the wedge insert 20 into the hollow internal channel 62 defined by the bottom surface of the second incline portion 14b, the top surface of the second base portion 12b, and the inside surface of the walls 18. Specifically, as seen for example in FIG. 2, the distal end 40 of the wedge insert 20 is inserted into the substantially rectangular opening defined by the second incline portion 14b, the walls 18, and the second base portion 12b. Once inserted, the wedge insert 20 is pushed distally further into the internal channel 62 within the head-up CPR board 10 which brings the top surface 48 of the wedge insert 20 into closer surface contact with the bottom surface of the second incline portion 14b. The second incline portion 14b, which was initially in a substantially horizontal position on top of the walls 18, begins to rotate about the second joint 24 in order to accommodate the incoming tapered shape of the insert wedge 20. As seen in FIG. 3 in which the second incline portion 14b has been lifted upwards to show the insertion of the wedge insert 20, the walls 18 help guide the insert wedge 20 and ensure that it is centrally placed underneath the second incline portion 14b within the internal channel 62. In certain embodiments, the wedge insert 20 is distally pushed until the distal end 40 makes contact with the brace 16, thereby providing the second incline portion 14b at a maximum inclined position as best seen in FIGS. 1A and 1B. According to certain embodiments, to lower the second incline portion 14b, a user grips the handle 44 and pulls the wedge insert 20 back in the proximal direction, thereby lowering the second incline portion 14b until it rests horizontally on top of the walls 18.

In one embodiment, to perform CPR using the head-up CPR board 10, the head-up CPR board 10 is first placed on a substantially firm and level surface such as the floor or the top of a table or counter or other area near to where the patient is located. The head-up CPR board 10 is initially in a ready to use state, specifically with the second incline portion 14b resting or disposed on top of the walls 18 in a substantially horizontal position and the wedge insert 20 removed. In certain embodiments, the head-up CPR board 10 is initially in a compacted or folded configuration as seen, for example in FIG. 4, and then assembled by manipulating the incline 14 and the base 12 about the respective joints 22, 24.

According to certain embodiments, once the head-up CPR board 10 has been placed, a backplate 54 of an automated CPR device or the entirety of an automated CPR device 56 is coupled or inserted into the indentation 26 that is defined within the first incline portion 14a, the second incline portion 14b, or a combination thereof. In certain embodiments, the automated CPR device 54, 56 is removably coupled to the head-up CPR board 10 after being placed or inserted into the indentation 26 so as to prevent any relative movement between the head-up CPR board 10 and the automated CPR device 54, 56. For example, after being fitted into the indentation 26, straps of hook and loop fabric are coupled to both a portion of the automated CPR device 54, 56 and a portion of the head-up CPR board 10 adjacent to the indentation 26. In a separate embodiment, the head-up CPR board 10 is prefabricated or preassembled with an automated CPR device 54, 56 already inserted therein. Each planar portion 34 is then actuated as described above in order to form each head support 32. Alternatively, according to certain other embodiments, each head support 32 is formed only after a patient has been laid down on the head-up CPR board 10 as discussed in further detail below.

According to certain embodiments, after CPR has been performed on a patient 1 lying supine on a flat or horizontal surface, the patient 1 is gently laid down on top of the head-up CPR board 10 with the wedge insert 20 initially removed so that the patient's neck and head are held at a substantially horizontal position relative to the base 12, while the chest of the patient 1 is disposed at an angle relative to the horizontal, for example at least 15° relative to the horizontal. The patient's head and neck rest between the head supports 32 while the patient's shoulders and back rest on a proximal end of the second incline portion 14b and the first incline portion 14a, respectively. According to certain embodiments, the patient's back is disposed directly over the indentation 26 which contains the backplate 54 of the automated CPR device. In certain related embodiments, the patient 1 is entirely disposed on top of the automated CPR device 56 when it is inserted into or disposed over the entire surface of the incline 14.

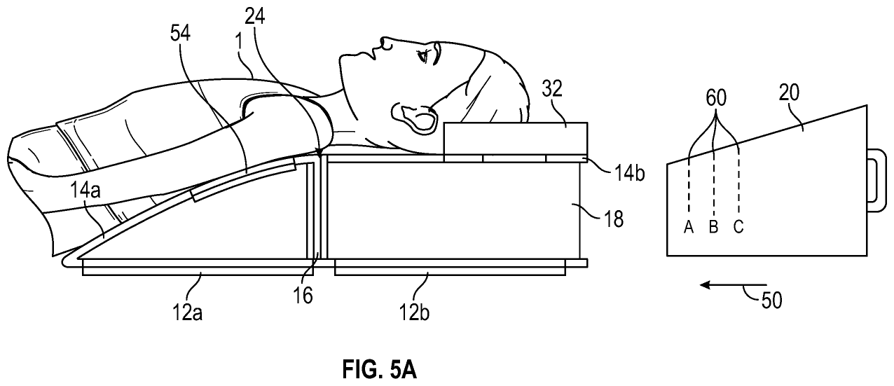

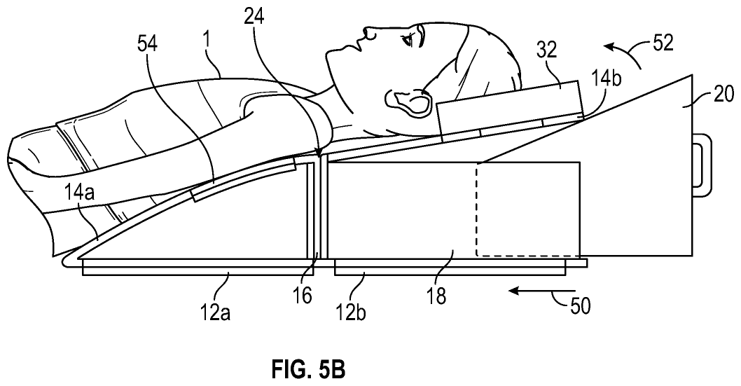

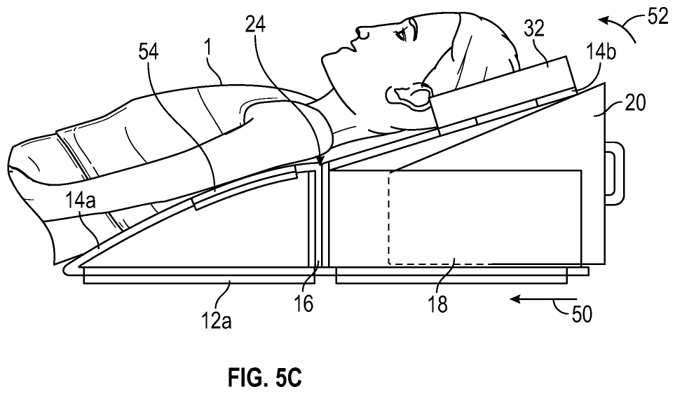

In one embodiment, the patient 1 is initially laid down on the head-up CPR board 10 without the wedge insert 20 as seen in FIG. 5A so that the user may perform traditional CPR on the patient 1 while the patient 1 is in the supine position, specifically with the second incline portion 14b disposed parallel to the second base portion 12b. According to certain embodiments, the patient 1 is disposed on the head-up CPR board 10 so that their back is on top of a first automated CPR device 54 while their neck and head rests within the head supports 32. Traditional CPR as used herein includes either performing an alternating series of chest compressions and mouth to mouth resuscitation, or use of the automated CPR device, or a combination thereof.

After performance of CPR has been started on the patient 1, the user makes a determination of when to insert the wedge insert 20 and to what degree the wedge insert 20 should be used. For example, as seen in FIGS. 5A-5C, after a predetermined amount of CPR cycles have been performed, or if visual examination of the patient 1 warrants it, the user aligns and then inserts the wedge insert 20 into the opening of the internal channel 62 defined beneath the second incline portion 14b and between the walls 18. As seen in FIG. 5B, for example, the user pushes or slides the wedge insert 20 in the distal direction denoted by arrow 50, the portion of the wedge insert 20 being inserted between the walls 18 appearing in broken outline within FIGS. 5B and 5C. Due to the tapered height of the wedge insert 20, distal movement of the wedge insert 20 in turn begins to rotate the second incline portion 14b and the patient 1 disposed thereon about the second joint 24 in the direction denoted by arrow 52 which effectively and efficiently raises the patient 1 from a substantially horizontal position to an inclined position. While the head and neck of the patient 1 are being slowly rotated upward, the torso of the patient 1 remains at a static angle on the first incline portion 14a comprising the first automated CPR device 54.

According to certain embodiments, the user continues to push the wedge insert 20 in the distal direction in predetermined increments or stages until the head and neck of the patient 1 have achieved, for example, a 30-degree angle relative to the surface that the head-up CPR board 10 is disposed upon.

For example, after performing CPR on the patient 1 for 30 seconds, the user slides the wedge insert 20 further in the distal direction indicated by arrow 50 which increases the relative angle between the second incline portion 14b and the second base portion 12b by, for example, five degrees. The user continues to perform CPR on the patient 1 for an additional 30 seconds before again sliding the wedge insert 20 in the direction of arrow 50 which further rotates the second incline portion 14b in the direction shown by arrow 52 by an additional five degrees as seen in FIG. 5C. This process continues to be repeated until a desired angle has been achieved or until the wedge insert 20 has been completely slid in the distal direction and inserted beneath the second incline portion 14b. According to certain embodiments, CPR is continually being performed on the patient 1, either by the first automated CPR device 54 or manually by the user, as the user is sliding the wedge insert 20 and adjusting the relative position of the second incline portion 14b.

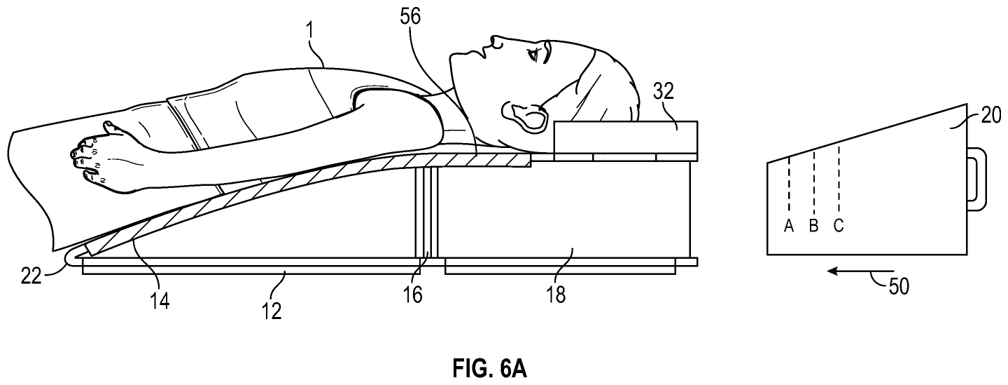

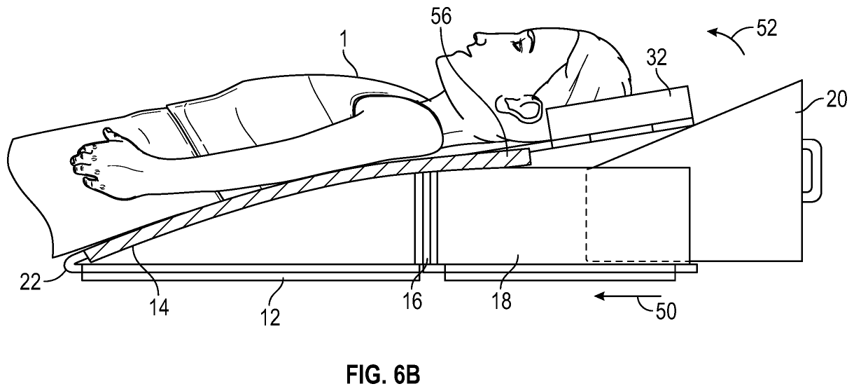

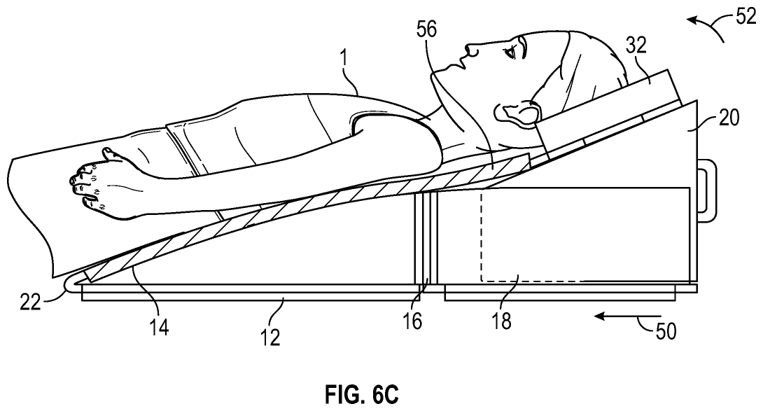

In a related embodiment where the incline 14 of the head-up CPR board 10 is a single or continuous surface that is configured to only rotate about the first joint 22 and comprises an indentation defined across its entire upward facing surface that is configured to accommodate an entire automated CPR device 56 therein, the entire incline 14 will rotate about the first joint 22 as the wedge insert 20 is moved distally by the user as seen in FIGS. 6A-6C.

Specifically, the patient 1 is initially laid down on the head-up CPR board 10 with the wedge insert 20 initiated at a “start” position as seen in FIG. 6A so that the user may perform traditional CPR on the patient 1 while the patient 1 is in the supine position, specifically with at least a portion of the incline 14 being disposed parallel to the base 12. According to certain embodiments, the patient 1 is disposed on the head-up CPR board 10 so that both their torso and their head and neck regions are disposed on top of the second automated CPR device 56, while their neck and head also rest within or between the head supports 32.

After performance of CPR has been started on the patient 1, the user makes a determination of when to insert the wedge insert 20 and to what degree the wedge insert 20 should be used. For example, as seen in FIGS. 6A-6C, after a predetermined amount of CPR cycles have been performed, or if visual examination of the patient 1 warrants it, the user aligns and then inserts the wedge insert 20 into the opening of the internal channel 62 defined beneath the incline 14 and between the walls 18. As seen in FIG. 6B, for example, the user pushes or slides the wedge insert 20 in the distal direction denoted by arrow 50, the portion of the wedge insert 20 being inserted between the walls 18 appearing in broken outline within FIGS. 6B and 6C. Due to the tapered height of the wedge insert 20, distal movement of the wedge insert 20 in turn begins to rotate the incline 14 about the first joint 2, and the patient 1 disposed thereon, in the direction denoted by arrow 52 which effectively and efficiently raises the patient from a substantially horizontal position to an inclined position. Unlike previous embodiments, both the head and neck of the patient 1 as well as the torso of the patient 1 are slowly rotated upward along with the incline 14 comprising the second automated CPR device 56.

According to certain embodiments, the user continues to push the wedge insert 20 in the distal direction in predetermined increments or stages until the torso and the head and neck of the patient 1 have achieved, for example, a 30-degree angle relative to the surface that the head-up CPR board 10 is disposed upon. For example, after performing CPR on the patient 1 for 30 seconds, the user slides the wedge insert 20 further in the distal direction indicated by arrow 50 which increases the relative angle between the incline 14 and the base 12, for example, five degrees. The user continues to perform CPR on the patient 1 for an additional 30 seconds before again sliding the wedge insert 20 in the direction of arrow 50 which further rotates the incline 14 in the direction shown by arrow 52 by an additional five degrees as seen in FIG. 6C. This process continues to be repeated until a desired angle has been achieved or until the wedge insert 20 has been completely slid in the distal direction and inserted beneath the incline 14. According to certain embodiments, CPR is continually being performed on the patient 1, either by the second automated CPR device 56 or manually by the user, as the user is sliding the wedge insert 20 and adjusting the relative position of the incline 14.

Regardless if a backplate 54 for an automated CPR device or if an entire automated CPR device 56 is being used, because the relative angle of the patient 1 is dependent upon how far the wedge insert 20 has been distally moved, the user may continually adjust the relative angle of the patient 1 by sliding the wedge insert 20 either distally or proximally by a corresponding amount until a desired position is achieved. For example, if the user slides the wedge insert 20 too far, or if it has been determined that other angles other than 30° relative to the horizontal are the optimum angle for treating the patient 1, the user may pull the wedge insert 20 back in the proximal direction until the correct angle is achieved.

In certain embodiments, the top surface 48, the at least one longitudinal wall 38 of the wedge insert 20, the surfaces of the walls 18, and/or the upward facing surface of second base portion 12b, for example, comprise a plurality of markings which indicate to the user the current relative angle of the incline 14 to the base 12 when the wedge insert 20 has been inserted into the internal channel 62. For example, as seen in FIG. 5A, the wedge insert 20 comprises a plurality of markings 60 on its longitudinal wall 38, each one of the plurality of markings 60 indicating a different relative degree of incline when the wedge insert 20 has been inserted into the interior of the head-up CPR board 10 up to that specific marking 60. According to one particular embodiment, when the wedge insert 20 has been inserted through the internal channel 62 so that a first marking “A” contacts or is disposed adjacent to the vertical edge of the walls 18, the user will know that the second incline portion 14b has reached a first corresponding relative angle between the second incline portion 14b and the base 12, for example 5° from the horizontal. When the wedge insert 20 has been inserted through the internal channel 62 so that a second marking “B” contacts or is disposed adjacent to the vertical edge of the walls 18, the user will know that the second incline portion 14b has reached a second corresponding relative angle between the second incline portion 14b and the base 12, for example 10° from the horizontal. The user repeats this process for as long as necessary or until a final desired relative angle between the incline 14 and the base 12 has been achieved. The plurality of markings 60 are seen in FIG. 5A as being alpha-numeric, however in certain embodiments, the plurality of markings 60 comprise different colors, images, or other appropriate visual indicators. In certain other embodiments, the plurality of markings 60 are a series of protrusions, bumps, notches, or other appropriate physical features which are configured to give the user tactile or haptic feedback as the head-up CPR board 10 is in use. In this manner and according to certain embodiments, the user may dispose the patient any angle ranging from 0° when the wedge insert 20 is not present, to a maximum angle, for example wherein the chest of the patient 1 is disposed at a 15° relative to the horizontal and wherein the head of the patient 1 is disposed at a 30° relative to the horizontal, when the wedge insert 20 has been slid to a maximum distal distance.

After performing CPR on the patient 1, the wedge insert 20 is removed from the interior of the head-up CPR board 10 by gripping the handle 44 and pulling the wedge insert 20 in the proximal direction which slowly rotates the second incline portion 14b back down into a substantially horizontal position. According to certain embodiments, after removing the wedge insert 20, the automated CPR device 54, 56 is deactivated or turned off and the patient 1 is lifted off of the incline 14. The backplate 54 of the automated CPR device or the entirety of the automated CPR device 56 disposed within the indentation 26 is then decoupled from the head-up CPR board 10 and removed from the indentation 26. The head-up CPR board 10 can be reused for another patient, however because the head-up CPR board 10 is comprised of durable, yet common materials, the user has the option of simply disposing of the head-up CPR board 10 after use.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

I claim:

1. A manual cardiopulmonary resuscitation (CPR) board for slowly raising the head of a patient to a recommended elevation comprising:
a base;
an adjustable incline coupled to the base;
an internal channel defined between the base and the incline;
a removable wedge insert configured to be inserted into the internal channel,
wherein the wedge insert is configured to rotate the incline relative to the base as it is being inserted into the internal channel.

2. The CPR board of claim 1 wherein the incline comprises:
a first incline portion coupled to the base; and
a second incline portion coupled to the first incline portion,
wherein the second incline portion is configured to rotate relative to the base as the wedge insert is inserted into the internal channel.

3. The CPR board of claim 1 further comprising an indentation defined within a surface of the incline, wherein the indentation is configured to accommodate at least a portion of an automated CPR device.

4. The CPR board of claim 2 further comprising an indentation defined within a surface of the first incline portion, wherein the indentation is configured to accommodate at least a portion of an automated CPR device.

5. The CPR board of claim 1 further comprising at least one wall coupled to the base, wherein at least a portion of the incline rests upon the at least one wall when the CPR board is in an unactuated configuration.

6. The CPR board of claim 1 wherein the internal channel is defined by a bottom surface of the incline, a top surface of the base, and at least one wall disposed between the incline and the base.

7. The CPR board of claim 1 wherein the incline is configured to rotate about a joint disposed between the incline and the base.

8. The CPR board of claim 2 wherein the second incline portion is configured to rotate about a joint disposed between the second incline portion and the first incline portion.

9. The CPR board of claim 1 further comprising a plurality of adjustable head supports disposed on the incline.

10. The CPR board of claim 9 wherein each of the plurality of adjustable head supports comprises a planar portion which is configured to be selectively parallel relative to the incline when the head support is an expanded position and bent along a seem when the head support is in an actuated position.

11. The CPR board of claim 1 wherein the wedge insert comprises at least one longitudinal wall comprising a tapered height.

12. The CPR board of claim 1 wherein the wedge insert comprises a plurality of markings disposed thereon, wherein each one of the plurality of markings corresponds to a relative angle between the incline and the base when the wedge insert has been inserted into the internal channel up to that respective one of the plurality of markings.

13. A method for performing cardiopulmonary resuscitation (CPR) on a patient by a user, the method comprising:
laying a patient on an incline of a CPR board;
performing CPR on the patient while the incline is disposed at a first position relative to a base of the CPR board;
manually raising the angle of the incline relative to the base of the CPR board until the incline is disposed at a second position relative to the base of the CPR board; and
performing CPR on the patient while the incline is disposed at the second position relative to the base of the CPR board.

14. The method of claim 13 wherein manually raising the angle of the incline relative to a base of the CPR board until the incline is disposed at a second position relative to the base of the CPR board comprises:
inserting a wedge insert into an internal channel defined within the CPR board; and
sliding the wedge insert in a distal direction through the internal channel,
wherein distal movement of the wedge insert increases contact between the wedge insert and the incline and rotates the incline relative to the base.

15. The method of claim 13 wherein laying the patient on the incline of the CPR board comprises laying the patient across a first incline portion and a second incline portion, and
wherein raising the angle of the incline relative to the base of the CPR board until the incline is disposed at the second position relative to the base of the CPR board comprises raising the angle of the second incline portion relative to the base.

16. The method of claim 13 wherein performing CPR on the patient while the incline is disposed at the first position relative to the base of the CPR board and wherein performing CPR on the patient while the incline is disposed at the second position relative to the base of the CPR board each comprise performing CPR on the patient with an automated CPR device coupled to the CPR board.

17. The method of claim 13 wherein laying the patient on the incline of the CPR board comprises laying the patient on an automated CPR device coupled to the CPR board.

18. The method of claim 13 further comprising disposing a head and neck of the patient within a pair of adjustable head supports disposed on the incline.

19. The method of claim 13 further comprising performing CPR on the patient while the angle of the incline is being manually raised relative to the base of the CPR board.

20. The method of claim 14 wherein sliding the wedge insert in a distal direction through the internal channel comprises sliding the wedge insert in the distal direction until a selected one of a plurality of markings disposed on the wedge insert is adjacently disposed to at least one wall defining the internal channel.
